(19) United States
(12) Patent Application Publication
(10) Pub. No.: US 2012/0195761 A1
(43) Pub. Date: Aug. 2, 2012

(54) WIND GENERATOR OF VERTICAL AXLE WITH INHIBITION OVERSPEED FLAPS

(76) Inventor: Myron Nouris, Panorama Thessaloniki (GR)

(21) Appl. No.: 13/500,134

(22) PCT Filed: Dec. 30, 2010
(86) PCT No.: PCT/GR10/00058

§ 371 Date: Apr. 4, 2012

(30) Foreign Application Priority Data
Jan. 8, 2010 (GR) 20100100011
Dec. 30, 2010 (GR) PCT/GR2010/000058

(51) Int. Cl. F03D 11/00

(52) U.S. Cl. 416/205

(57) ABSTRACT

The invention refers to a wind generator of electrical current production with a vertical axle and inhibition over-speed laps. the wind generator is setted on a steady duct on the upper place of which there is a thrust bearing. There are three (internal) laps mounted on the generator and under the thrust bearing. These flaps are totally the same. They are setted in 120 degrees corner among them. Three other laps (external) are fixed on these flaps. The external flaps are constructed with aerodynamic cross section. These laps have special ribs and housings for edge support while a wire rope mounted to the internal of the laps prevents the spreading in case of fracture. According to the invention we have internal and external flaps. Because of the rotation speed increasement the external flaps gradually change place so the incidence angle of the wind changes and the flaps resist to the wind flow keeping the rotation speed steady.

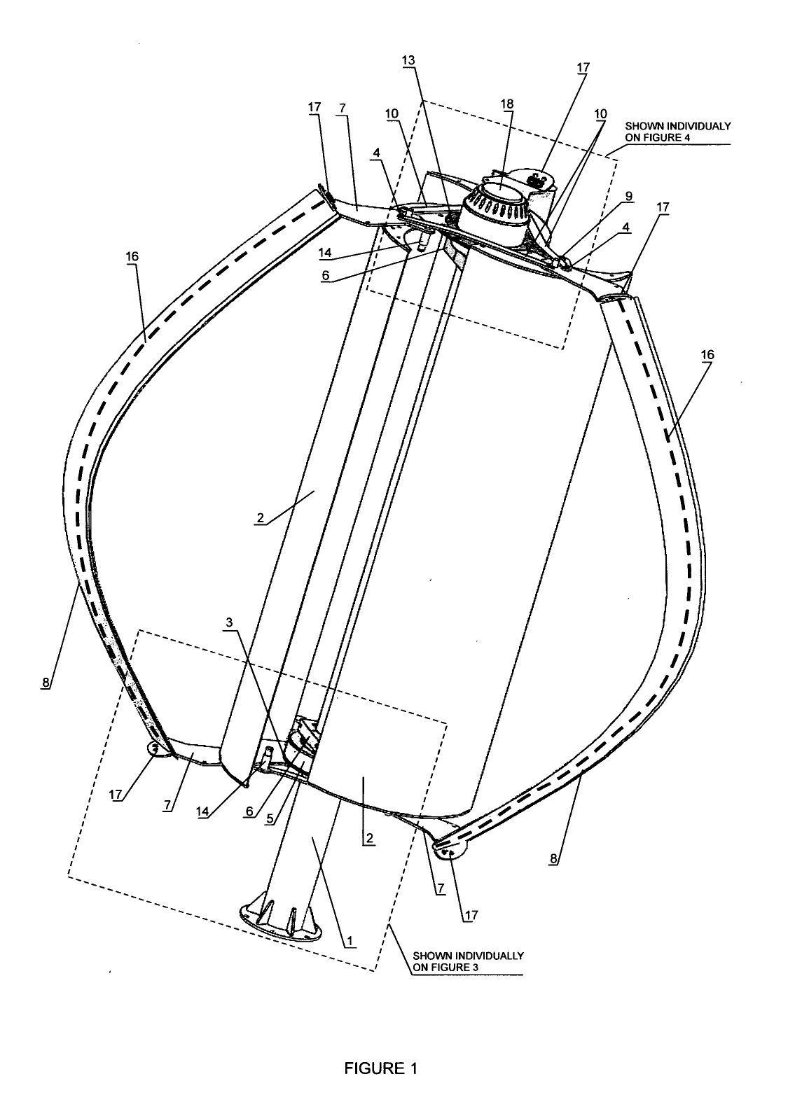

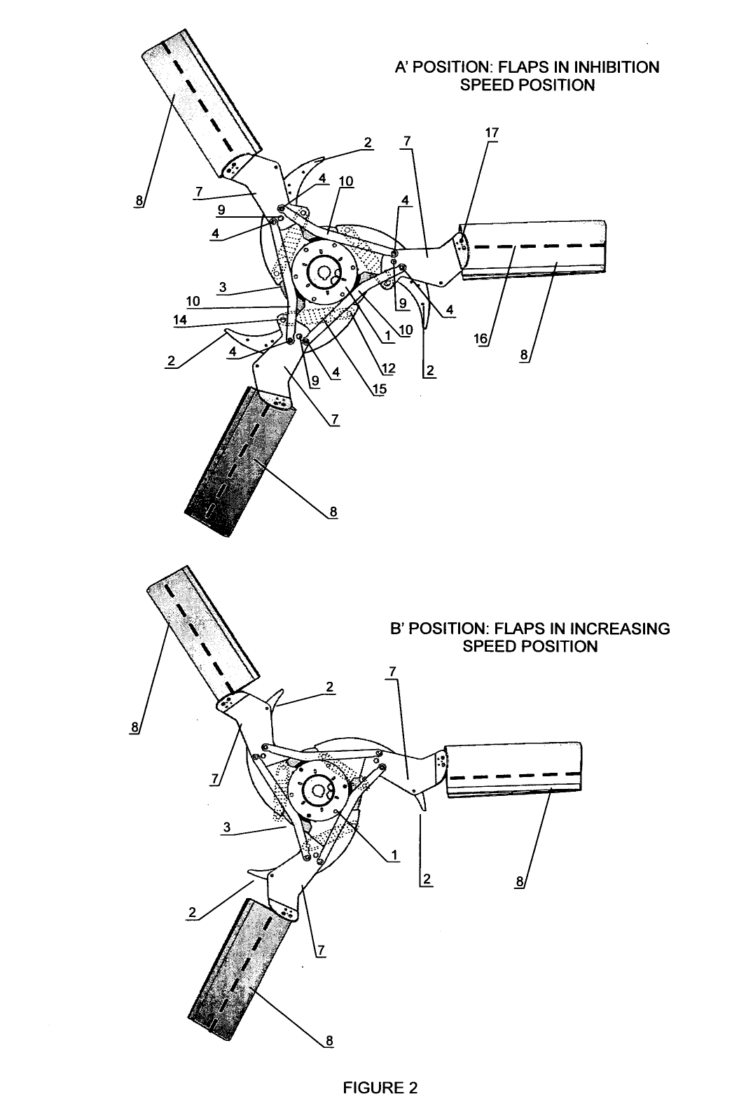

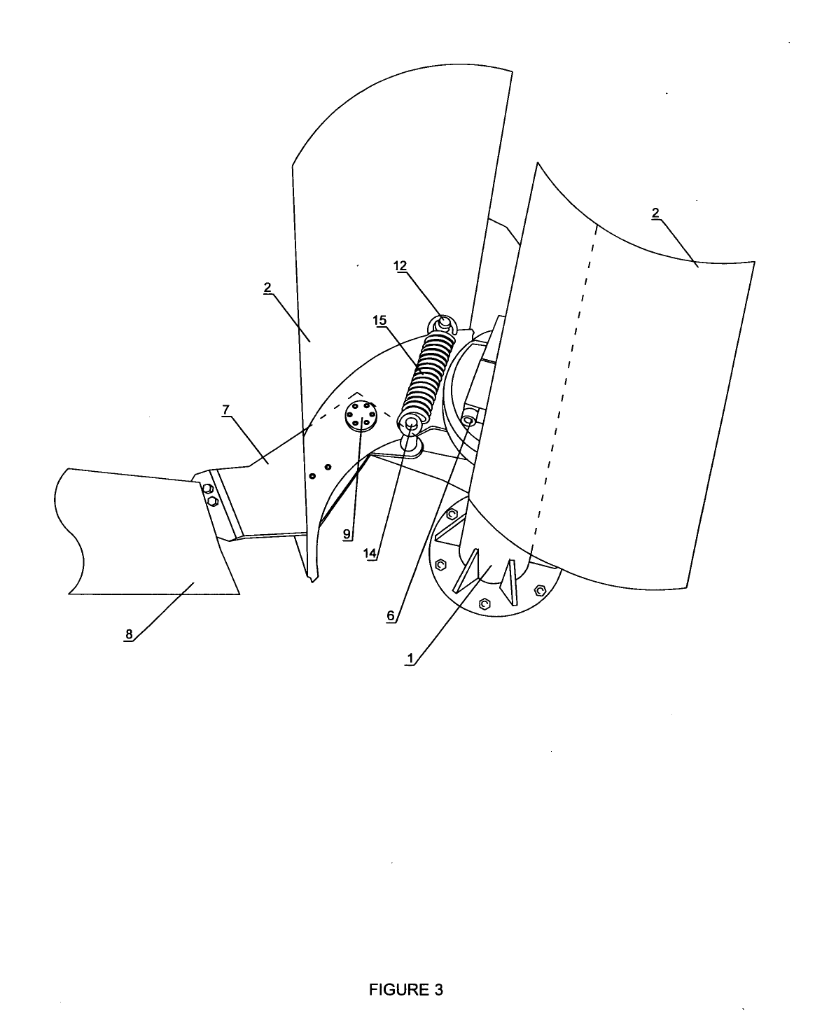

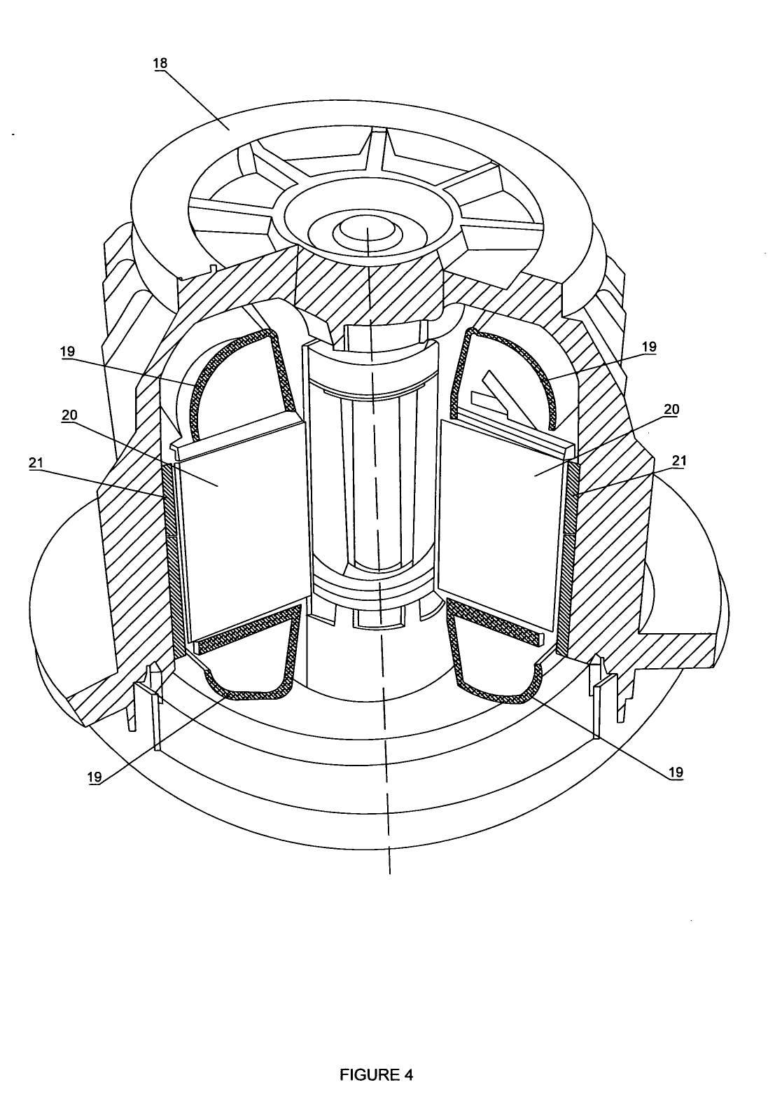

The invention is referred in a wind generator of electrical current production with a vertical axle and inhibition overspeed laps, in case of maximum speed wind blow.

The wind generators are popular and used from lots of people and constitute one of the green forms of electrical current production. Using these systems, the moving energy of the wind successfully turns into rotary, and this has as an effect the electric current production (with the proper connection) in areas with high average of wind blow.

The wind generators usually use laps situated in a horizontal axle which rotates with the wind blow. The rotated axle is connected with an electrical current generator. The size and the way of construction vary from manufacturer to manufacturer.

The electrical current wind generators have some disadvantages as for example the non-controlled development of the high speed rotation in case of strong winds (high speed winds), or the major inactivity at the beginning which presumes low performance in low wind speeds. The inactivity of the system is owed mainly to the need for inclined laps that can afford the pressure through a strong wind.

Another disadvantage of the wind generators is that these systems are intended for use in applications and installations out of residential areas since their construction and installation need a special restraining procedure and should not be accessed from possible visitors for safety reasons. These installations perform major values of electric current and it is practically difficult and financially unprofitable producing electric current for domestic autonomic consumption (per wind generator and house). Constructions of this kind have another serious disadvantage. The flaps have a reversion towards the axle of each flap in order to avoid the excessive developing speed, so by this way they reduce the air resistance and eventually the rotation speed of the axle. The reversion mechanism usually is a combination of electronic and mechanic systems. The reliability of these systems is not the demanded one. The laps many times receive a different inclination and this detuning affects the generator performance.

The present invention refers to an electric current wind generator of a vertical axle and laps that avoid the excessive speed development.

The present invention aims on covering the needs of a small (domestic) electrical current production having solved all the technical difficulties and disadvantages of the manufacturers so far. Those that have been achieved are the following, small mass of the construction, simple installation, minimized inactivity at the beginning, easy to access, safe maintenance and most of all, having the maximum number of rotations controlled by combing the internal and external laps.

The special characteristic of this invention is that the wind generator is setted on a steady duct on the upper place of which there is a thrust bearing. There are three (internal) laps mounted on the generator and under the thrust bearing. These flaps are constructed from stainless sheet metal and are totally the same. They also are setted in 120 degrees corner among them and having the maximum possible accuracy in order to have perfect balancing of the system and not to reduce the performance, because of frictions or vibrations. Three other laps (external) are fixed on these flaps. The external flaps are constructed with aerodynamic cross section, from special durable plastic to sun irradiation and whether conditions. These laps have special ribs and housings for edge support while a wire rope mounted to the internal of the laps prevents the spreading in case of fracture. The internal flaps provide a starting with the less wind speed possible, while the external laps provide high rpm, strain and performance.

According to the invention, this is achieved with the air entrance into the internal flaps and the force creation which rotates them. The external flaps (suspension flaps) contribute to even bigger force growth and rotation speed increase because of their aerodynamic cross-section. At the same time the succeeded speed is even bigger from the one that would be succeeded if these laps where missing and this happens due to increasing area and the aerodynamic created from the external laps. The wind speed increases gradually more than the desired, flaps change place gradually also, so the incidence angle of the wind changes so that the flaps resist to the wind flow keeping the rotation speed steady and avoiding the excessive speed that could be harmful for the electrical power production unit and the wind generator itself. So, finally, the performance to the steady power production system is the desired.

The invention is mentioned below through an example and with a report to the attached drawings, in which:

Picture 1 shows a perspective image of the invention with a full development of the wind generator parts.

Picture 2 shows the corresponding ground plan of the invention. Picture 3 shows a detail of the construction where the spring application holds the inhibition flaps. Picture 4 shows the half cut section of the generator.

The invention is constituted from a steady vertical base (1) circular cross sectioned and restrained with screws in steady ground. The whole construction is rotated on the base. The three internal flaps (2) constitute the main resistance center and air flow. While the air passes through them, a rotating movement is created. The flaps are supported through screws from their edges in circular discs (3 and 13) mounted above and below the steady vertical base (1).

The flaps mounting to the bottom of the base (1) is performed through a pillow block (5) and its stabilization is performed through a divided chock (6). The special items (7) are supported on the internal flaps by joint (9) and the inhibition flaps (8) (external flaps) are mounted on their edges. These special items (7) constitute the base for the inhibition flaps and they are mounted with a pin which creates a joint on the internal flaps (2). The inhibition flap bases are connected between them with special metal plates (10) in order to take the same inclination angle according to the direction of the wind, since they are moving together, the one after the other. This can be achieved because the special metal plates (10) are mounted to the edges of the flaps with opposite joints (4) which are setted to the special items (7). Their shape is similar to obtuse angle and in combination with their position, they declare the margin of the place changing of the inhibition flaps which is the incidence corner of the air on them. There is a pin (14) on the metal plate supports (7) of the external flaps facing the center of the construction parallel to the rotation axle. A spring (15) is suspended on this pin and the other edge is on pin (12) which is nailed on the internal surface of the opposite internal flag. This joint (9) allows to the inhibition flags to have the ability to change position, in combination with the special metal plates (10) and the spring (15) and during the maximum wind speed to take the default position from construction which keeps rpm of the generator steady. The final position of the flaps appears because of the big centrifugal force developing to the inhibition flaps. This position overcomes the prestress of the spring (15) so the incidence angle of the wind to the inhibition flags changes. As a conclusion, the final rpm of the flaps and of the generator stabilizes and the already existing springs replace the flaps to their initial position, the one when air speed is inside the desired limits. The spring tension is adjusted to resist inside the desired air speed limits—rpm and can be readjusted in case the manufacturer desires more or less final rpm.

The inhibition flaps are designed with a special aerodynamic cross section and they have a wire rope (16) in their internal for safety reasons, which prevents the item spreading in case of fracture. The specific wire rope ends to a special item (17) which provides the desired stretch.

The application of the generator (18) on the construction is performed through a common generator embedment to the eccentricities of the construction. Contrary to the regular operation of motors and generators, we have though operation steady winding of the coils (19) and of the ferromagnetic core (20) and rotation of the skin which carries to the internal permanent magnets (21).

1. The characteristic of the vertical axle wind generator with inhibition flaps of excessive speed is the internal flaps (2) that carries which have a steady wind incidence angle and external flaps (8) which have variable wind incidence angle, so that they either increase the rotation of the generator or decrease this rotation, keeping the generator rpm up to the desired maximum limit without causing any damage to the mechanism or producing electrical current more than the desired.

2. The rotation of the external flaps (inhibition flaps) (8) consists a basic characteristic according to claim 1 and is achieved through a mounting with the joint (9) of the external flap on the internal flaps (2) and the appliance of a pair of springs (15) at the same time (one to the upper support and one to the low support). The pair bends on two pins. The one (12) is mounted to the internal of the internal flap and the other (14) is mounted to the special metal plate (7) that connects the internal with the external flaps. The air speed change and the speed increasment over the desired limit changes the flap place and this has as a conclusion to increase the rotation speed in low wind speeds, while in bigger rotation speed from the desired, the rotation speed of the generator suspends (brakes) in order to be steady and according to the manufacturer's predictions. The inhibition flap bases are connected to each other with special metal plates (10) in order to take the same inclination angle towards the wind direction, since they move together drifting to each other. This can be achieved because the special metal plates (10) have to their edges opposite joints (4) in obtuse angle, in combination with their position. By this way they can define the margin of the place change of the inhibition flaps, meaning the incidence angle of the air on them.

3. The characteristic of the vertical axle wind generator with inhibition flaps of excessive speed is the support to two points. The one is the upper point where the electrical current generator (18) exists and the second is the point below where the pillow block (5) exists. The drive is direct and the axle load (1) symmetrical. The axle (1) supporting the construction is steady.

4. The incidence angle of the air is adjusted from spring pairs (15) (one to the upper support and one to the support below). The pairs are that much as the corresponding external flaps. The same construction can be made with three or four or five internal flaps and the same number of external flaps. The choice of the three pairs of flaps is more functional and preferable according to the cost, the weight and the performance.
